(19) United States
(12) Patent Application Publication
(10) Pub. No.: US 2019/0029224 A1
(43) Pub. Date: Jan. 31, 2019

(54) PET PAW WASHER

(71) Applicants: Thomas B. Murphy, Arlington, TX (US); Ellis N. Shamoon, Dallas, TX (US); Lawrence J. Yeung, Cewisville, TX (US)

(72) Inventors: Thomas B. Murphy, Arlington, TX (US); Ellis N. Shamoon, Dallas, TX (US); Lawrence J. Yeung, Cewisville, TX (US)

(21) Appl. No.: 15/663,698

(22) Filed: Jul. 28, 2017

(51) Int. Cl. A01K 13/00; A46B 7/04; A46B 9/02; A46B 15/00

(52) U.S. Cl. CPC A01K 13/001; A46B 7/042; A46B 2200/1093; A46B 15/0091; A46B 9/026

(57) ABSTRACT

The present invention provides a container, insert, and top assembled to form a pet paw washer. An animal's paw is then inserted through the opening in the top and moved back and forth relative to the bristles within the container.

### BACKGROUND OF THE INVENTION

### Field of the Invention

This invention relates to containers with internal brushes, more particularly pet paw washers.

### Description of the Background Art

Pet paw washers are devices used to remove dirt, mud, debris and other contamination from the paws of pets which have been outdoors. Muddy paws are a problem when the animal is ready to come indoors or into a vehicle, as the paws will transfer contamination to everything they touch.

Most prior pet paw washers have included an internally-facing brush in a container that can be slipped over the paw, then moved back and forth along the length of the paw to remove and contain the contamination for later disposal. These prior pet paw washers have been deficient in that they are hard to use, hard to clean, ineffective, and expensive to manufacture.

A need therefore exists for an improved pet paw washer that is easy to use and clean, effective, and inexpensive to manufacture.

### SUMMARY OF THE INVENTION

The present invention provides a pet paw washer that has an insert with bristles that can be inserted and removed from a container. The insert and container can be frustroconical in shape, such that the insert can be readily inserted into the container until it stops in a location where matching frustroconical surfaces on the insert and in the container are congruent, adjacent and fixed relative to each other during use. The matching frustroconical shapes permit easy removal of the insert after use for cleaning. The insert can also be made of a flexible material, so that the insert is flat and sheet-like when the insert is removed, but bendable to a configuration where it fits into the container for use.

### BRIEF DESCRIPTION OF THE DRAWINGS

A more complete understanding of the invention and its advantages will be apparent from the Detailed Description taken in conjunction with the accompanying Drawings, in which:

FIG. 1 is a perspective view of pet paw washer constructed in accordance with the invention;

FIG. 2 is a partially broken-away side view of the pet paw washer of FIG. 1;

FIG. 3 is an exploded view of the pet paw washer;

FIG. 4 is a perspective view of the insert used in the pet paw washer;

FIGS. 5A and 5B are partial enlarged views of the insert; and

FIG. 6 is view of the pet paw washer in operation.

### DETAILED DESCRIPTION OF THE INVENTION

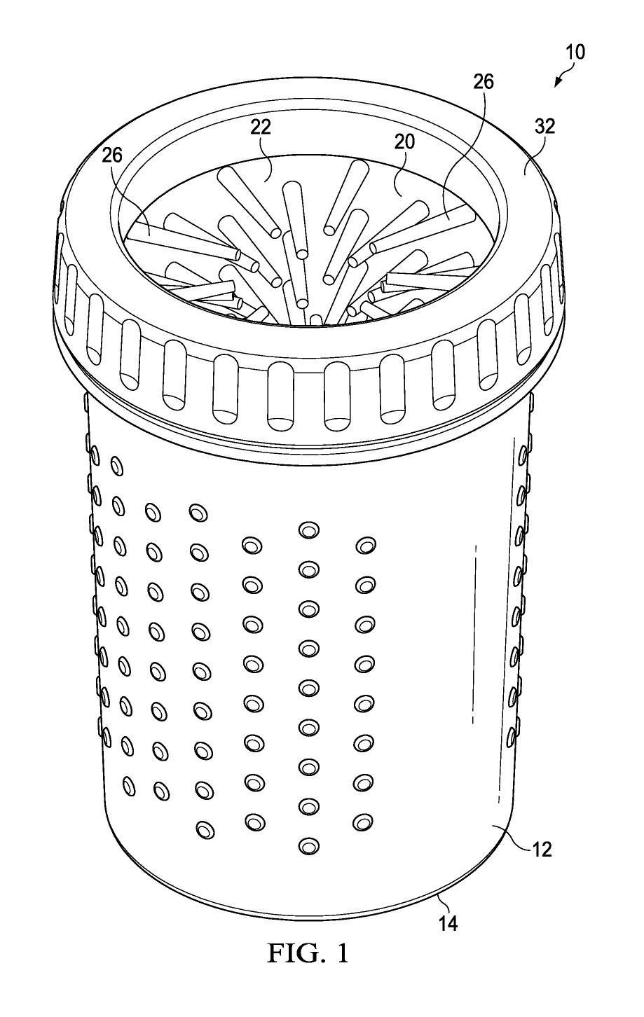

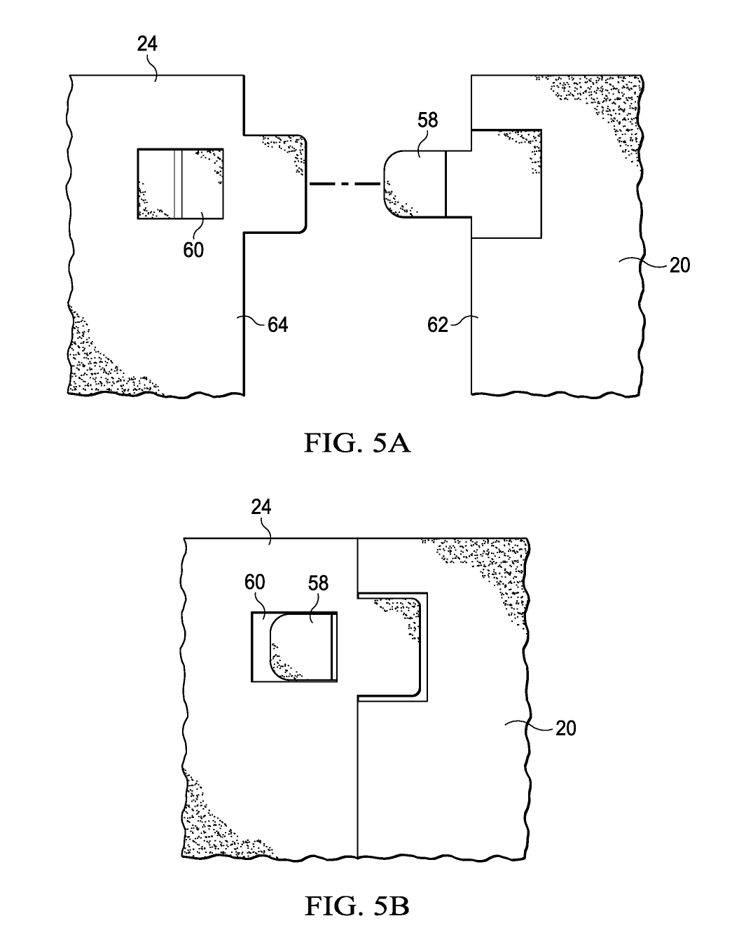

Referring to FIGS. 1-6, where like numerals indicate like and corresponding elements, a pet paw washer 10 includes a container 12 having a closed end 14, an open end 16, and an inner frustroconical surface 18. An insert 20 has an inner surface 22 and an outer frustroconical surface 24. A multiplicity, i.e., a very large number, of bristles 26 extend from the insert inner surface 22 into the container 12 to form an interior, hollow brush.

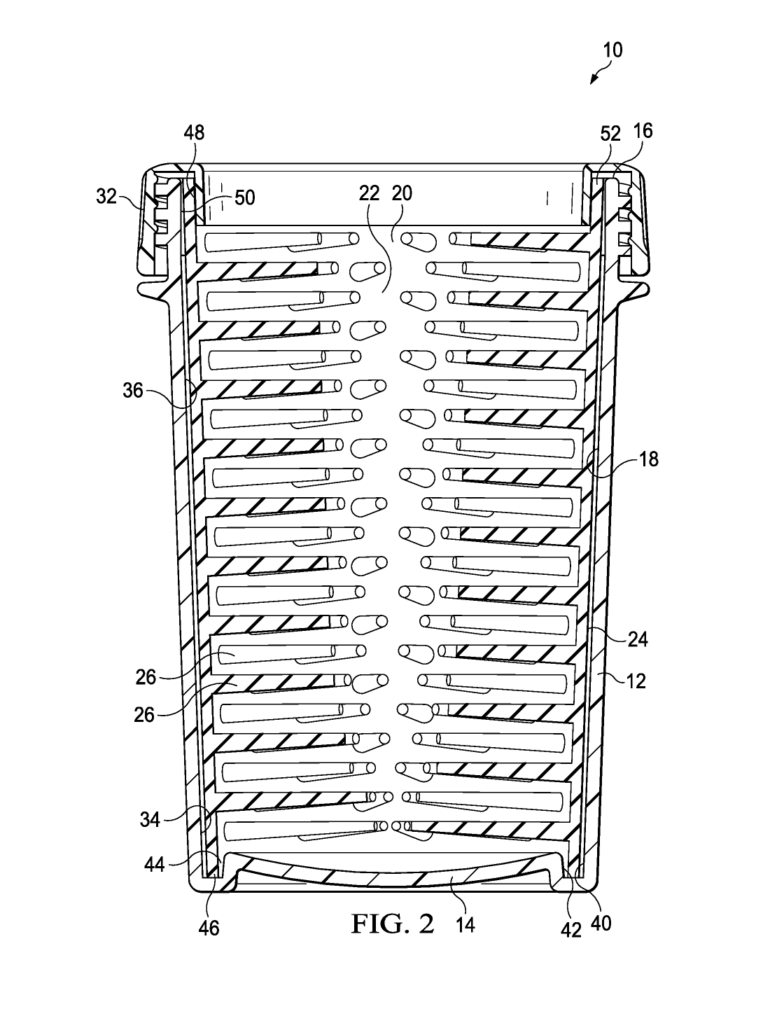

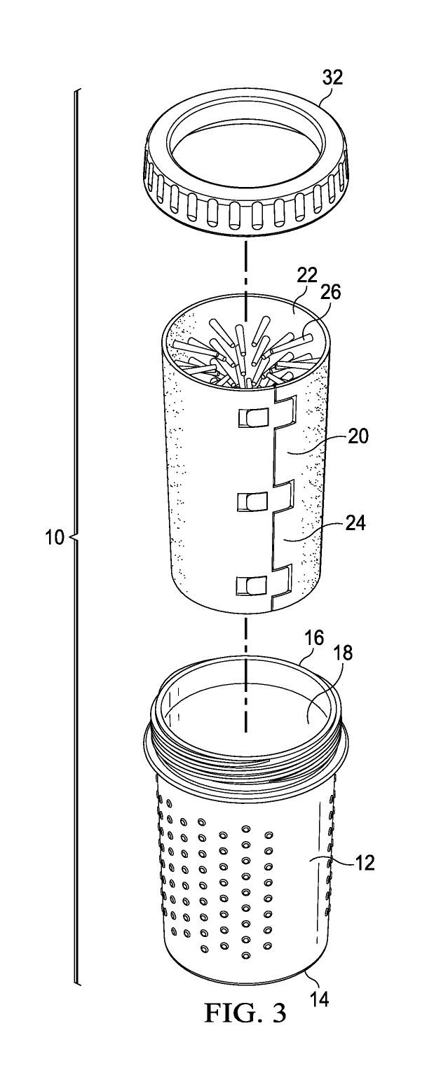

A best shown in FIG. 2, the container inner frustroconical surface 18 and the insert outer frustroconical surface 24 are substantially congruent and adjacent one another in their entireties. The insert 20 is therefore snugly interfitted to the container 12, and the bristles foifu an interior, hollow brush, when the pet paw washer is in use. Insert 20 is also readily removable from the open end 16 of the container when the pet paw washer is not in use, as best shown in FIG. 3.

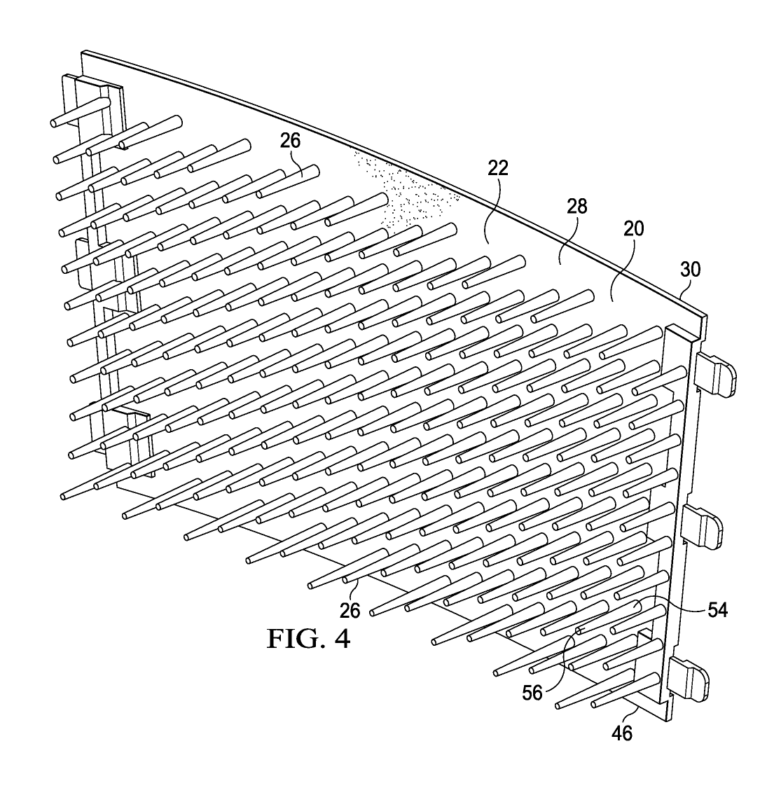

In a preferred embodiment, the insert 20 is formed of an easily-bendable, resilient, pliable material such as silicone rubber. As best shown in FIG. 4, insert 20 in this embodiment is dimensioned so the insert 20 has parallel, planar inner and outer surfaces 28,30 when removed from the container and laid flat on a supporting planar surface (not shown). Insert 20 has the insert outer surface 24 substantially congruent and adjacent to the container inner surface 18 when the insert 20 is bent and interfitted to the container 12. Surfaces 28,30 need not be frustroconical but could be cylindrical or oval-shaped, for example, though frustroconical shapes are preferred for ease of manufacture when used with plastic molded parts and for ease of assembly and disassembly by users. The “lay-flat” configuration of the removed insert 12, with parallel planar walls, is also optional, again motivated by ease of manufacture by molding.

A removable annular top 32 is fitted to the open end 16 of the container 12. Top 32 can be connected to the container by way of screw threads as illustrated or by way of other techniques, such as by snap fit. The annular configuration of top 32 permits a large opening through the top into the container.

When insert 20 is fully engaged with container 12, as shown in FIGS. 1 and 2, the bristles 26 extend radially from the insert inner surface 22 toward the center of the container. The bristles 26 are longer in a bottom section 34 of the container proximate the closed end 14 than in an upper section 36 of the container proximate the open end 16. This enables the bottom of a paw to be cleaned more thoroughly when fully inserted.

Opposing walls 40, 42 define a lower pocket groove 44 in the closed end 14 of the container interfitted with a lower edge 46 of the insert. Similarly, walls 48 in the annular top are opposed to a top portion 50 of the container inner frustroconical surface 18 proximate the open end 16. Walls 48 in the annular top and the top portion 50 of the container inner frustroconical surface define an upper pocket groove interfitted with an upper edge 52 of the insert. The pocket grooves thus defined keep the insert from collapsing inwardly when the washer is agitated back and forth to clean a pet paw.

Bristles 26 are widely-staggered frustroconical bodies with larger ends 54 (FIG. 4) at the insert inner surface 22 and tapering to smaller distal ends 56.

Connecting elements 58,60 are provided at first and second sides 62,64 of the insert 20. The connecting elements are adapted and arranged to connect the sides when the insert is bent and inserted into the container and to disconnect the sides when the insert is removed from the container. In the illustrated embodiment the connecting elements are cooperating tabs and slots to form several stab locks, however, other connecting elements could be used such as a zipper or felt/loop fastening.

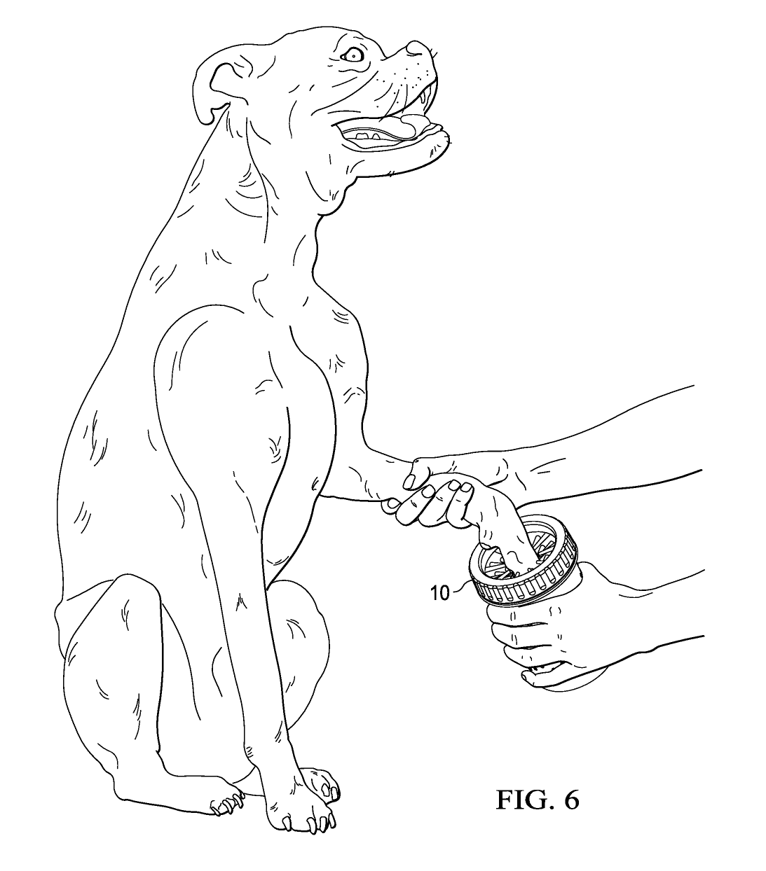

In operation, as shown in FIG. 6, the container, insert, and top are assembled to form the pet paw washer. An animal's paw is then inserted through the opening in the top and moved back and forth relative to the bristles within the container.

Whereas, the present invention has been described with respect to a specific embodiment thereof, it will be understood that various changes and modifications will be suggested to one skilled in the art, and it is intended to encompass such changes and modifications as fall within the scope of the appended claims.

We claim:

1. A pet paw washer, comprising:
a container having a closed end, an open end, and an inner frustroconical surface;
an insert with an inner surface and an outer frustroconical surface, with a multiplicity of bristles extending from the insert inner surface; and
the container inner frustroconical surface and the insert outer frustroconical surface being substantially congruent and adjacent one another in their entireties, such that (a) the insert is snugly interfitted to the container, and the bristles form an interior, hollow brush, when the pet paw washer is in use, and (b) the insert is readily removable from the open end of the container when the pet paw washer is not in use.

2. The paw washer of claim 1 with a removable annular top fitted to the open end of the container.

3. The paw washer of claim 1 with the bristles extending radially from the insert inner surface toward the center of the container.

4. The pet paw washer of claim 1 with the bristles being longer in a bottom section of the container proximate the closed end than in an upper section of the container proximate the open end.

5. The pet paw washer of claim 1 with opposing walls defining a lower pocket groove in the closed end of the container interfitted with a lower edge of the insert.

6. The pet paw washer of claim 2 with (a) walls in the annular top opposing a top portion of the container inner frustroconical surface proximate the open end, and (b) the walls in the annular top and the top portion of the container inner frustroconical surface defining an upper pocket groove interfitted with an upper edge of the insert.

7. The pet paw washer of claim 1 with the bristles (a) being widely-staggered frustroconical bodies with larger ends at the insert inner frustroconical surface and (b) tapering to smaller distal ends.

8. A pet paw washer, comprising:
a container having a closed end, an open end and an inner surface;
an insert with an inner surface and an outer surface, with a multiplicity of bristles extending from the insert inner surface;
the insert being interfitted to, and readily removable from, the container; and
the insert being formed of an easily-bendable, resilient, pliable material, with the insert dimensioned so the insert (a) has parallel, planar inner and outer surfaces when removed from the container and laid flat on a supporting planar surface, and (b) has the insert outer surface substantially congruent and adjacent to the container inner surface when the insert is bent and interfitted to the container.

9. The pet paw washer of claim 8 with a removable annular top fitted to the open end of the container.

10. The pet paw washer of claim 8 with the bristles extending radially from the insert inner surface toward the center of the container.

11. The pet paw washer of claim 8 with the bristles being longer in a bottom section of the container proximate the closed end than in an upper section of the container proximate the open end.

12. The pet paw washer of claim 8 with opposing walls defining a lower pocket groove in the closed end of the container interfitted with a lower edge of the insert.

13. The pet paw washer of claim 9 with (a) walls in the annular top opposing a top portion of the container inner surface proximate the open end, and (b) the walls in the annular top and the top portion of the container inner surface defining an upper pocket groove interfitted with an upper edge of the insert.

14. The pet paw washer of claim 8 with the bristles (a) being widely-staggered frustroconical bodies with larger ends at the insert inner frustroconical surface and (b) tapering to smaller distal ends.

15. The pet paw washer of claim 8 with connecting elements at first and second sides of the insert, the connecting elements adapted and arranged to connect the sides when the insert is bent and inserted into the container and disconnect the sides when the insert is removed from the container.

16. The pet paw washer of claim 15 with the connecting elements being a stab lock connection with cooperating tabs and slots.

17. The pet paw washer of claim 8 with the container inner surface and insert outer surface both being frustroconical.

18. A pet paw washer, comprising:
a container having a closed end, an open end, and an inner frustroconical surface;
an insert with an inner surface and an outer frustroconical surface, with a multiplicity of bristles extending from the insert inner surface into the container to form an interior, hollow brush;
the container inner frustroconical surface and the insert outer frustroconical surface being substantially congruent and adjacent one another in their entireties, such that (a) the insert is snugly interfitted to the container, and the bristles form an interior, hollow brush, when the pet paw washer is in use, and (b) the insert is readily removable from the open end of the container when the pet paw washer is not in use;
the insert being formed of an easily-bendable, resilient, pliable material, with the insert dimensioned so the insert (a) has parallel, planar inner and outer surfaces when removed from the container and laid flat on a supporting planar surface, and (b) has the insert outer surface substantially congruent and adjacent to the container inner surface when the insert is bent and interfitted to the container;
with a removable annular top fitted to the open end of the container;
with the bristles extending radially from the insert inner surface toward the center of the container;
with the bristles being longer in a bottom section of the container proximate the closed end than in an upper section of the container proximate the open end;
with opposing walls defining a lower pocket groove in the closed end of the container interfitted with a lower edge of the insert;
with (a) walls in the annular top opposing a top portion of the container inner frustroconical surface proximate the open end and (b) the walls in the annular top and the top portion or the container inner frustroconical surface defining an upper pocket groove interfitted with an upper edge of the insert;
with the bristles (a) being widely-staggered frustroconical bodies with larger ends at the insert inner frustroconical surface and (b) tapering to smaller distal ends; and
with connecting elements at first and second sides of the insert, the connecting elements adapted and arranged to connect the sides when the insert is bent and inserted into the container and disconnect the sides when the insert is removed from the container.
